(19) United States
(12) Patent Application Publication
(10) Pub. No.: US 2007/0133820 A1
(43) Pub. Date: Jun. 14, 2007

(54) Channel capacity improvement in wireless mobile communications by voice SNR advancements

(76) Inventor: Alon Konchitsky, Cupertino, CA (US)

Correspondence Address: STEVEN A. NIELSEN;ALLMAN & NIELSEN, P.C, 100 Larkspur Landing Circle, Suite 212, LARKSPUR, CA, 94939, US

(21) Appl. No.: 11/306,029

(22) Filed: Dec. 14, 2005

(51) Int. Cl. H04B 15/00

(52) U.S. Cl. 381/94.1

(57) ABSTRACT

A voice microphone collects sound waves from the user as well as unwanted background noise. A second background microphone collects ambient sound. The inputs from the two microphones retain their analog format. The signal from the background microphone is subtracted from the input of the voice microphone. The resulting signal has an increased signal to noise ratio.

### BACKGROUND OF THE INVENTION

(1) Field of the Invention

The present invention provides an increased SNR and thus dramatic increases in the realized channel capacity of wireless network or cellular mobile communication system. The capacity or “C” of a channel is often expressed in the Shannon theorem as:
C=BW×log₂(1+SNR)
where
C is the channel capacity expressed in bits per second inclusive of error correction;
BW is the bandwidth of the channel expressed in hertz; and
SNR is the signal-to-noise ratio of the communication signal to the noise.

The present invention relates to communication system suitable for use in cell phones, radio telephones, cordless telephones, PDAs, laptop computers and in other wireless mobile devices or environments where noise reduction is desired.

(2) The Related Art

Other two microphone noise reduction systems are known in the related art. U.S. Pat. No. 6,415,034 (the “Hietanen patent”) describes a second background noise microphone located within an earphone unit or behind an ear capsule. Digital signal processing is used to create a noise canceling signal which enters the speech microphone. Unfortunately, the effectiveness of the method disclosed in the Hietanen patent is compromised by acoustical leakage, that is where ambient or environmental noise leaks past the ear capsule and into the speech microphone. The Hietanen patent also relies upon expensive digital circuitry.

U.S. Pat. No. 5,969,838 (the “Paritsky patent”) discloses a noise reduction system utilizing two fiber optic microphones that are placed side-by-side to one another. Unfortunately, the Paritsky patent discloses a system using light guides and other relatively expensive and/or fragile components not suitable for the rigors of cell phones and other mobile devices.

Therefore, there is a need in the art for a method of noise reduction that is robust, suitable for mobile use, and inexpensive to manufacture.

### BRIEF SUMMARY OF THE INVENTION

The present invention overcomes shortfalls in the related art by using two standard microphones that are positioned on a device to collect primarily either voice input and/or background noise. The background microphone is fully exposed to the environment and does not need to be concealed or otherwise protected. The two standard microphones are analog, rugged and inexpensive to manufacture. A robust and inexpensive analog sum circuit subtracts the background noise from the voice input which yields a clearer voice signal and a higher signal to noise ratio.

### BRIEF DESCRIPTION OF THE DRAWINGS

FIG. 1 is a front view of a phone constructed in accordance with the disclosed invention.

FIG. 2 is a side view of a phone constructed in accordance with the disclosed invention with two microphones on the side of the phone.

FIG. 3 is a side view of a phone constructed in accordance with the disclosed invention with the voice microphone on the front of the phone and the background microphone on the back of the phone.

FIG. 4 is a block diagram of an analog sum circuit connected to the speech microphone and background microphone.

FIG. 5 is a block diagram of a 1 80 degree phase inverter connected to the background microphone signal.

FIG. 6 is a graph illustrating the increased capacity of a channel as a function of increased SNR.

### DETAILED DESCRIPTION OF THE INVENTION

In a channel, the existence of noise is the most limiting factor to the channel capacity. FIG. 6 demonstrates the relationship between SNR and channel capacity limit as presented by Claude Shannon.

The present invention is directed toward the design and construction of a two (or more) microphone system that yields an increased SNR. A background microphone captures ambient sound or noise which is subtracted from the sound captured from the voice signal microphone. The resulting input has an increased SNR as compared to the typical single microphone system. In the single microphone system, both background noise and the desired voice single enter the communication system. In the present invention, the background noise entering the voice single microphone is removed by subtracting analogous background noise captured by the separate background microphone.

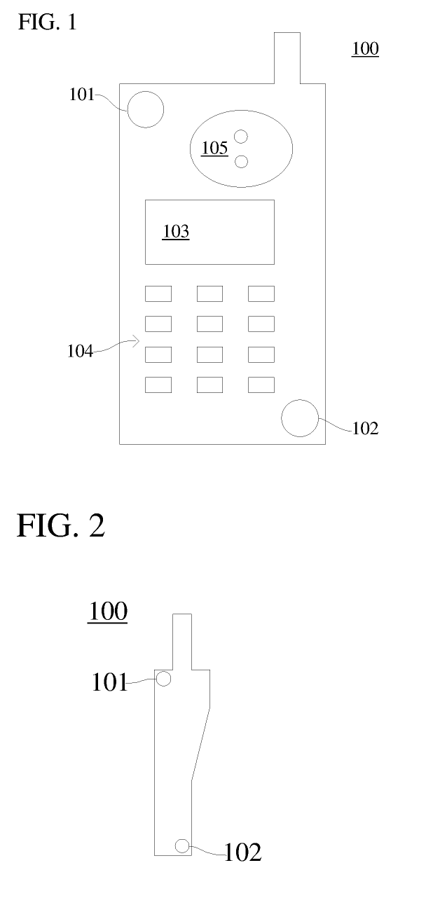

The present invention contemplates a myriad of multi-microphone configurations such as the two microphone scheme shown on FIG. 1. A phone 100 may be a cell phone or other communication device. In FIG. 1 the phone 100 has voice microphone 102 and the front and a background microphone 101 also on the front side. For reference, the phone 100 has a display 103, keypad 104, and ear speaker 105. FIG. 1 shows the best mode known to date.

FIG. 2 shows one of the many alternative embodiments with a side view of a typical communication device 100 wherein the voice signal microphone 102 and background signal microphone 101 are located on the side of the phone.

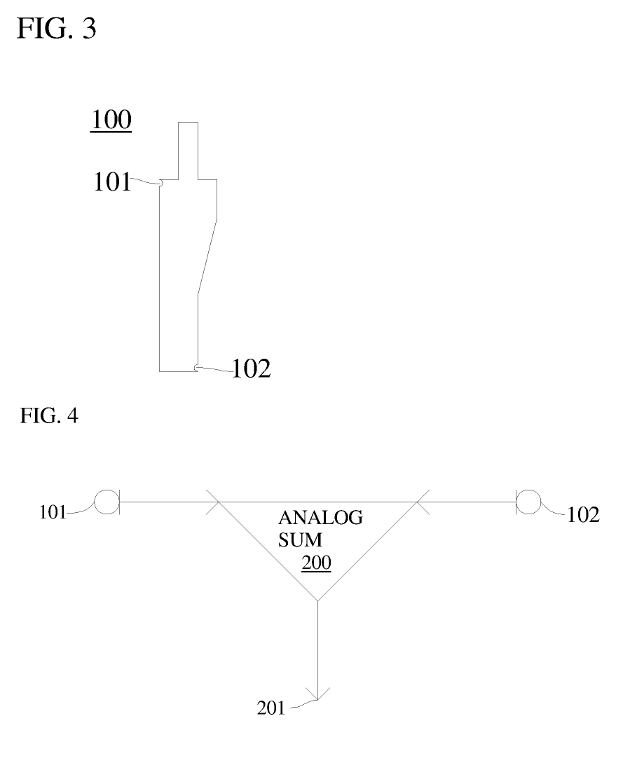

FIG. 3 shows one of the many alternative embodiments with a voice signal microphone 102 on the front of the phone 100 and a background microphone 101 placed on the back side of the phone. FIG. 3 is a side view of the phone.

FIG. 4 is a block diagram of background microphone 101 entering Sum Circuit 200 and voice signal microphone 102 also entering the Sum Circuit. The Sum Circuit creates an output at 201 wherein the background input of 101 is removed from the voice signal input of 102.

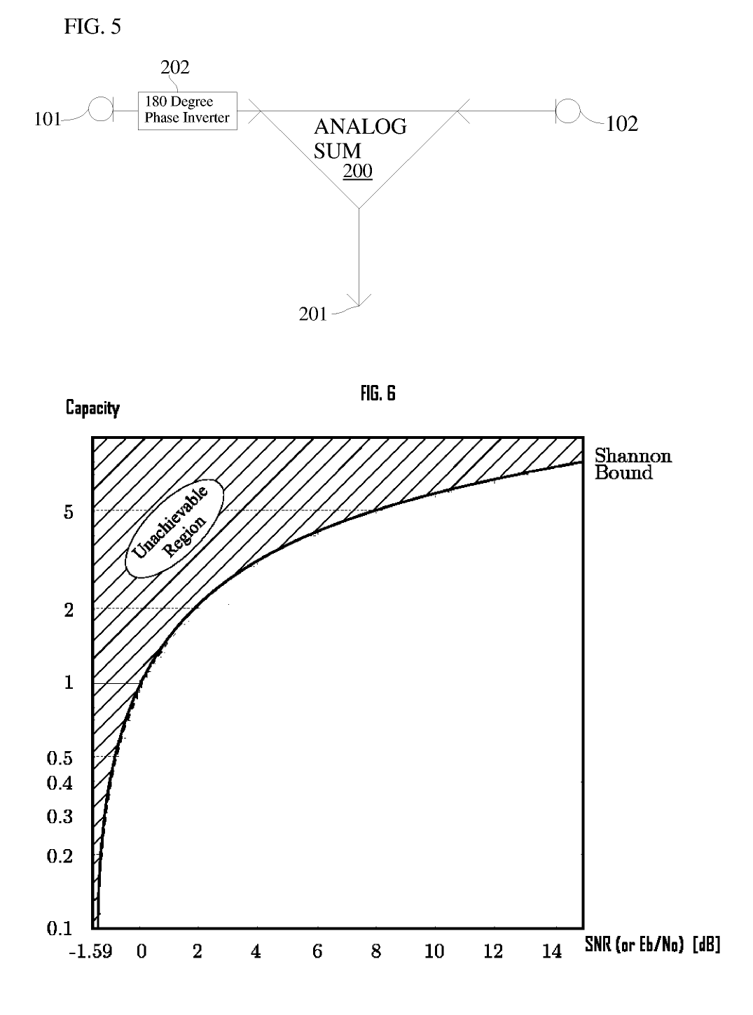

FIG. 5 is a block diagram of background microphone 101 entering a 180 degree Phase Inverter 202 after which the inverted signal enters the Sum Circuit 200. Voice signal input 102 enters the other input to Sum Circuit 200. The increased SNR output exits the Sum Circuit at output 202.

FIG. 6 is a graph showing the relationship between increasing SNR on the horizontal x axis and increasing signal channel capacity on the vertical y axis.

What is claimed is:

1. A method of noise reduction comprising the steps of:
(a) detecting a speech signal from a microphone;
(b) detecting background noise from a microphone; and
(c) subtracting the background noise from the speech signal.

2. The method of claim 1 wherein an analog sum circuit is used to subtract the background noise from the speech signal.

3. The method of claim 1 wherein the background noise signal is inverted.

4. The method of claim 1 wherein the speech signal is detected by a microphone located relatively close to the speaker's mouth and background noise is detected by a microphone located relatively further from the mouth of the speaker.

5. A noise reducing device comprising:
(a) means for detecting background noise;
(b) means for detecting a speech signal; and
(c) means for subtracting the background noise from the speech signal.

6. The device of claim 5 wherein an analog sum circuit is used to subtract the background noise from the speech signal.

7. The device of claim 5 wherein the background noise signal is 180 degrees inverted.

8. The device of claim 7 wherein the inverted background signal enters a sum circuit with the speech signal.
